(19) United States
(12) Patent Application Publication
(10) Pub. No.: US 2019/0092683 A1
(43) Pub. Date: Mar. 28, 2019

(54) ANTIREFLECTIVE, SCRATCH-RESISTANT GLASS SUBSTRATE AND METHOD FOR MANUFACTURING THE SAME

(71) Applicants: AGC GLASS EUROPE, Louvain-La-Neuve (BE); AGC GLASS COMPANY NORTH AMERICA, Alpharetta, GA (US); ASAHI GLASS CO LTD, Tokyo (JP); QUERTECH INGENIERIE, Caen (FR)

(72) Inventors: Benjamine NAVET, Louvain-La-Neuve (BE); Pierre BOULANGER, Couthuin (BE); Denis BUSARDO, Gonneville Sur Mer (FR)

(73) Assignees: AGC GLASS EUROPE, Louvain-La-Neuve (BE); AGC GLASS COMPANY NORTH AMERICA, Alpharetta, GA (US); AGC Inc., Chiyoda-ku (JP); QUERTECH INGENIERIE, Caen (FR)

(21) Appl. No.: 16/092,346

(22) PCT Filed: Mar. 13, 2017
(86) PCT No.: PCT/EP2017/055848

§ 371 Date: Oct. 9, 2018

(30) Foreign Application Priority Data
Apr. 12, 2016 (EP) 16164909.0

(51) Int. Cl. C03C 23/00; C03C 4/00

(52) U.S. Cl. CPC C03C 23/0055; C03C 3/087; C03C 4/00

(57) ABSTRACT

The invention concerns a method for manufacturing scratch-resistant antireflective glass substrates by ion implantation, comprising ionizing a source gas of N₂ so as to form a mixture of single charge and multicharge ions of N, forming a beam of single charge and multicharge ions of N, by accelerating with an acceleration voltage comprised between 20 kV and 30 kV and an ion dosage comprised between 5×10¹⁶ ions/cm² and 10¹⁷ ions/cm². The invention further concerns scratch-resistant antireflective glass substrates comprising an area treated by ion implantation with a mixture of simple charge and multicharge ions according to this method.

The present invention relates to an antireflective, scratch-resistant glass substrate and a method of manufacturing the same. It also relates to the use of an antireflective, scratch-resistant glass substrate, particularly as glazing.

Most antireflective glass substrates are obtained by the deposition of coatings on the glass surface. Reduction of light reflectance is obtained by single layers having refractive indexes that are lower than the refractive index of the glass substrate or that have a refractive index gradient. Some antireflective coatings are stacks of multiple layers that make use of interference effects in order to obtain a significant reduction of light reflectance over the whole visible range. Other coatings present a certain degree of porosity so as to obtain a low refractive index. As a rule such coatings are more sensitive to mechanical and/or chemical attack than the glass itself and the higher the coating's performance, the higher its sensitivity.

Another antireflective glass substrate has been disclosed in FR1300336. Here an antireflection effect is obtained by implanting ions of noble gases at a concentration of 10 atomic % up to depths of 100 nm or 200 nm into the surface of a glass substrate. However noble gases are relatively expensive and the need to reach such high concentrations of the implanted noble gas ions in the glass substrate increases the risk of creating important damage to the glass network. The ion implantation of ions of noble gases creates micro-bubbles in the glass substrates that leads to lowered reflectance. However creating such cavities leads to decreased mechanical durability, in particular to scratches.

There is therefore a need in the art to provide a simple, inexpensive method of making an antireflective glass substrate that has mechanical durability in particular to scratches at least equivalent to that of untreated glass.

According to one of its aspects, the subject of the present invention is to provide a method for producing an antireflective, scratch-resistant glass substrate.

According to another of its aspects, the subject of the present invention is to provide an antireflective, scratch-resistant glass substrate.

The invention relates to a method for producing an antireflective, scratch-resistant glass substrate comprising the following operations:
providing a N₂ source gas,
ionizing the source gas so as to form a mixture of single charge ions and multicharge ions of N,
accelerating the mixture of single charge ions and multicharge ions of N with an acceleration voltage so as to form a beam of single charge ions and multicharge ions, wherein the acceleration voltage is comprised between 15 kV and 30 kV and the ion dosage is comprised between 5×10¹⁶ ions/cm² and 10¹⁷ ions/cm²,
providing a glass substrate,
positioning the glass substrate in the trajectory of the beam of single charge and multicharge ions.

The inventors have surprisingly found that the method of the present invention providing an ion beam comprising a mixture of single charge and multicharge ions of N, accelerated with the same specific acceleration voltage and at such specific dosage, applied to a glass substrate, leads to a reduced reflectance and at the same time to an unmodified or even increased scratch resistance.

Advantageously the reflectance of the resulting glass substrate is at most 6.5%, preferably at most 6%, more preferably at most 5.5%. At the same time the scratch resistance is unmodified or even increased, that is the scratch resistance in terms of critical load is comprised between 100% and 135%, more preferably between 105% and 135%, of the scratch resistance of the untreated glass substrate. Most surprisingly this low level of reflectance is reached whereas the concentration of implanted N is below 2 atomic % throughout the implanted depth and furthermore it was expected initially that the implantation of nitrogen would lead to silicon-nitrogen bonds, creating silicon oxynitride-comprising material layers having higher refractive index than the untreated glass substrate.

In the present invention the N₂ gas is ionized so as to form a mixture of single charge ions and multicharge ions of N. The beam of accelerated single charge ions and multicharge ions may comprise various amounts of the different N ions, preferably N⁺, N²⁺ and N³⁺. Example currents of the respective ions are shown in Table 1 below (measured in milli Ampère).

TABLE 1
Ions of N

| | |
|---|---|
| N⁺ | 0.55 mA |
| N²⁺ | 0.60 mA |
| N³⁺ | 0.24 mA |

The key ion implantation parameters are the ion acceleration voltage and the ion dosage.

The positioning of the glass substrate in the trajectory of the beam of single charge and multicharge ions is chosen such that certain amount of ions per surface area or ion dosage is obtained. The ion dosage, or dosage is expressed as number of ions per square centimeter. For the purpose of the present invention the ion dosage is the total dosage of single charge ions and multicharge ions. The ion beam preferably provides a continuous stream of single and multicharge ions. The ion dosage is controlled by controlling the exposure time of the substrate to the ion beam. According to the present invention multicharge ions are ions carrying more than one positive charge. Single charge ions are ions carrying a single positive charge.

In one embodiment of the invention the positioning comprises moving glass substrate and ion implantation beam relative to each other so as to progressively treat a certain surface area of the glass substrate. Preferably they are moved relative to each other at a speed comprised between 0.1 mm/s and 1000 mm/s. The speed of the movement of the glass relative to the ion implantation beam is chosen in an appropriate way to control the residence time of the sample in the beam which influences ion dosage of the area being treated.

The method of the present invention can be easily scaled up so as to treat large substrates of more than 1 m², for example by continuously scanning the substrate surface with an ion beam of the present invention or for example by forming an array of multiple ion sources that treat a moving substrate over its whole width in a single pass or in multiple passes.

According to the present invention the acceleration voltage and ion dosage are preferably comprised in the following ranges.

TABLE 2

| | | | most preferred |
|---|---|---|---|
| parameter | general range | preferred range | range |
| Acceleration | 15 to 30 | 20 to 28 | 20 to 25 |
| voltage [kV] | | | |
| Ion dosage | 5 × 10¹⁶ to | 6 × 10¹⁶ to 9 × | 8 × 10¹⁶ to 9 × 10¹⁶ |
| [ions/cm²] | 10¹⁷ | 10¹⁶ | |

The inventors have found that ion sources providing an ion beam comprising a mixture of single charge and multicharge ions, accelerated with the same acceleration voltage are particularly useful as they may provide lower dosages of multicharge ions than of single charge ions. It appears that a glass substrate having a low reflectance and a scratch resistance similar to or better than the scratch resistance of untreated glass substrate, may be obtained with the mixture of single charge ions, having higher dosage and lower implantation energy, and multicharge ions, having lower dosage and higher implantation energy, provided in such a beam. The implantation energy, expressed in Electron Volt (eV) is calculated by multiplying the charge of the single charge ion or multicharge ion with the acceleration voltage.

In a preferred embodiment of the present invention the temperature of the area of the glass substrate being treated, situated under the area being treated is less than or equal to the glass transition temperature of the glass substrate. This temperature is for example influenced by the ion current of the beam, by the residence time of the treated area in the beam and by any cooling means of the substrate.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams.

The method of the present invention is preferably performed in a vacuum chamber at a pressure comprised between 10⁻² mbar and 10⁻⁷ mbar, more preferably at between 10⁻⁵ mbar and 10⁻⁶ mbar.

An example ion source for carrying out the method of the present invention is the Hardion+RCE ion source from Quertech Ingénierie S.A.

The reflectance is measured in the visible light range on the side of the substrate treated with the method of the present invention using illuminant D65, 2°.

The present invention also concerns the use of a mixture of single charge and multicharge ions of N to decrease the reflectance of a glass substrate and at the same time to maintain or increase the scratch resistance of the glass substrate, the mixture of single charge and multicharge ions of N being implanted in the glass substrate with a dosage and an acceleration voltage effective to decrease the reflectance of the glass substrate and at the same time to obtain a scratch resistance in terms of critical load comprised between 100% and 135% of the scratch resistance in terms of critical load of the untreated glass substrate.

Preferably the mixture of single and multicharge ions of N is used with an acceleration voltage and an ion dosage efficient to reduce the reflectance of a glass substrate to at most 6.5%, preferably to at most 6%, more preferably to at most 5.5%.

Preferably the mixture of single and multicharge ions of N is used with an acceleration voltage and an ion dosage efficient increase the scratch resistance in terms of critical load at a value comprised between 105% and 135% of the scratch resistance in terms of critical load of the untreated glass substrate.

The reflectance of the untreated glass substrate is about 8%, the scratch resistance of untreated glass substrate depends on the glass composition and on the production conditions.

According to the present invention, the mixture of single charge and multicharge ions of N preferably comprises N⁺, N²⁺, and N³⁺.

According to a preferred embodiment of the present invention, mixture of single charge and multicharge ions of N comprises a lesser amount of N³⁺ than of N⁺ and N²⁺ each. In a more preferred embodiment of the present invention, the mixture of single charge and multicharge ions of N comprises 40-70% of N⁺, 20-40% of N²⁺, and 2-20% of N³⁺.

According to the present invention the acceleration voltage and ion dosage effective to reduce reflectance of the glass substrate and at the same time increase its scratch resistance are preferably comprised in the following ranges.

TABLE 3

| | | | most preferred |
|---|---|---|---|
| parameter | general range | preferred range | range |
| Acceleration | 15 to 30 | 20 to 28 | 20 to 25 |
| voltage [kV] | | | |
| Ion dosage | 5 × 10¹⁶ to 10¹⁷ | 6 × 10¹⁶ to 9 × | 8 × 10¹⁶ to 9 × 10¹⁶ |
| [ions/cm²] | | 10¹⁶ | |

The present invention also concerns an ion implanted glass substrate having reduced reflectance and unmodified or even increased scratch resistance, wherein the implanted ions are single charge ions and multicharge ions of N.

Advantageously the glass substrate of the present invention has a reflectance that is decreased from about 8% to at most 6.5%, preferably to at most 6%, more preferably to at most 5.5%. At the same time the scratch resistance in terms of critical load is comprised between 100% and 135%, preferably between 105% and 135% of the scratch resistance in terms of critical load of the untreated glass substrate.

The reflectance is measured on the treated side with D65 illuminant and a 2° observer angle. The scratch resistance is measured on the treated side as described below.

Advantageously the implantation depth of the ions may be comprised between 0.1 μm and 1 μm, preferably between 0.1 μm and 0.5 μm.

The glass substrate of the present invention is usually a sheet like glass substrate having two opposing major surfaces. The ion implantation of the present invention may be performed on one or both of these surfaces. The ion implantation of the present invention may be performed on part of a surface or on the complete surface of the glass substrate.

In another embodiment, the present invention also concerns glazings incorporating antireflective, scratch-resistant glass substrates of the present invention, no matter whether they are monolithic, laminated or multiple with interposed gas layers. In such embodiment, the substrate may be tinted, tempered, reinforced, bent, folded or ultraviolet filtering.

These glazings can be used both as internal and external building glazings, and as protective glass for objects such as panels, display windows, glass furniture such as a counter, a refrigerated display case, etc., also as automotive glazings such as laminated windshields, mirrors, antiglare screens for computers, displays and decorative glass.

The glazing incorporating the antireflection glass substrate according to the invention may have interesting additional properties. Thus, it can be a glazing having a security function, such as the laminated glazings. It can also be a glazing having a burglar proof, sound proofing, fire protection or anti-bacterial function.

The glazing can also be chosen in such a way that the substrate treated on one of its faces with the method according to the present invention, comprises a layer stack deposited on the other of its faces. The stack of layers may have a specific function, e.g., sun-shielding or heat-absorbing, or also having an anti-ultraviolet, antistatic (such as slightly conductive, doped metallic oxide layer) and low-emissive, such as silver-based layers of the or doped tin oxide layers. It can also be a layer having anti-soiling properties such as a very fine TiO₂ layer, or a hydrophobic organic layer with a water-repellent function or hydrophilic layer with an anti-condensation function.

The layer stack can be a silver comprising coating having a mirror function and all configurations are possible. Thus, in the case of a monolithic glazing with a mirror function, it is of interest to position an antireflective, scratch-resistant glass substrate of the present invention with the treated face as face 1 (i.e., on the side where the spectator is positioned) and the silver coating on face 2 (i.e., on the side where the mirror is attached to a wall), the antireflective, scratch-resistant face 1 according to the invention thus preventing the splitting of the reflected image.

In the case of a double glazing (where according to convention the faces of glass substrates are numbered starting with the outermost face), it is thus possible to use the antireflective, scratch-resistant treated face as face 1 and the other functional layers on face 2 for anti-ultraviolet or sun-shielding and 3 for low-emissive layers. In a double glazing, it is thus possible to have at least one antireflection stack on one of the faces of the substrates and at least one layer or a stack of layers providing a supplementary functionality. The double glazing can also have several antireflective, scratch-resistant treated faces, particularly at least on faces 2, 3, or 4.

The substrate may also undergo a surface treatment, particularly acid etching (frosting), the ion implantation treatment may be performed on the etched face or on the opposite face.

The substrate, or one of those with which it is associated, can also be of the printed, decorative glass type or can be screen process printed.

A particularly interesting glazing incorporating the antireflective, scratch-resistant glass substrate according to the invention is a glazing having a laminated structure with two glass substrates, comprising a polymer type assembly sheet between an antireflective, scratch-resistant glass substrate of the present invention, with the ion implantation treated surface facing away from the polymer assembly sheet, and another glass substrate. Preferably, the another glass substrate is an antireflective, scratch-resistant glass substrate according to the present invention. The polymer assembly sheet can be from polyvinylbutyral (PVB) type, polyvinyl acetate (EVA) type or polycyclohexane (COP) type.

This configuration, particularly with two heat treated, that is bent and/or tempered, substrates, makes it possible to obtain a car glazing and in particular a windshield of a very advantageous nature. The standards require cars to have windshields with a high light transmission of at least 75% in normal incidence. Due to the incorporation of the heat treated antireflective, scratch-resistant glass substrate in a laminated structure of a conventional windshield, the light transmission of the glazing is particularly improved, so that its energy transmission can be slightly reduced by other means, while still remaining within the light transmission standards. Thus, the sun-shielding effect of the windshield can be improved, e.g., by absorption of the glass substrates. The light reflection value of a standard, laminated windshield can be brought from 8% to less than 5%.

The glass substrate according to this invention may be a glass sheet of any thickness having the following composition ranges expressed as weight percentage of the total weight of the glass:

| | |
|---|---|
| SiO₂ | 35-85%, |
| Al₂O₃ | 0-30%, |
| P₂O₅ | 0-20% |
| B₂O₃ | 0-20%, |
| Na₂O | 0-25%, |
| CaO | 0-20%, |
| MgO | 0-20%, |
| K₂O | 0-20%, and |
| BaO | 0-20%. |

The glass substrate according to this invention is preferably a glass sheet chosen among a soda-lime glass sheet, a borosilicate glass sheet, or an aluminosilicate glass sheet.

The glass substrate according to this invention preferably bears no coating, at least on the side being subjected to ion implantation.

The glass substrate according to the present invention may be a large glass sheet that will be cut to its final dimension after the ion implantation treatment or it may be a glass sheet already cut to its final size.

Advantageously the glass substrate of the present invention may be a float glass substrate. The ion implantation method of the present invention may be performed on the air side of a float glass substrate and/or the tin side of a float glass substrate. Preferably the ion implantation method of the present invention is performed on the air side of a float glass substrate.

In an embodiment of the present invention the glass substrate may be a chemically strengthened glass substrate.

The optical properties were measured using a Hunterlab Ultrascan Pro Spectrophotometer.

Scratch resistance of the glass substrates was determined by a progressive load scratch test. This test corresponds to a load ramp applied during a defined displacement of the sample beneath it. Here measurements were performed with a microscratch tester “MicroCombi tester” from CSM Instruments. The scratch test consists in moving a diamond stylus that is placed on the substrate surface along a specified line under a linearly increasing normal force and with a constant speed. The scratches were made with a Rockwell diamond indenter with a radius of 100 μm (100 μm tip).

The stylus was moved along a straight line of 1.5 cm in length. The speed was kept constant at 5 mm/min. The normal force (load) applied on the stylus was increased from 0.03 N at the start of the scratch to 30 N at the end of the scratch. During the scratch, the penetration depth, the acoustic emission and the tangential force are recorded and the aspect of the scratch is observed as a function of the penetration depth.

The load applied on the stylus when the first cracks appear at the glass surface is the critical load with 100 μm tip.

For each sample the average of at least three measurements is determined. The higher the scratch resistance the higher the load at which the first cracks appear.

On the equipment used for the present experiments the maximum possible load was limited to 30 N.

On samples with a very high scratch resistance no cracks appear even when the maximum load is applied to the stylus.

### DETAILED DESCRIPTION OF PARTICULAR EMBODIMENTS

The ion implantation examples were prepared according to the various parameters detailed in the tables below using an RCE ion source for generating a beam of single charge and multicharge ions. The ion source used was a Hardion+RCE ion source from Quertech Ingénierie S.A.

All samples had a size of 10×10 cm² and were treated on the entire surface by displacing the glass substrate through the ion beam at a speed between 20 and 30 mm/s.

The temperature of the area of the glass substrate being treated was kept at a temperature less than or equal to the glass transition temperature of the glass substrate.

For all examples the implantation was performed in a vacuum chamber at a pressure of 10⁻⁶ mbar.

Using a RCE ion source, ions of N were implanted in 4 mm thick regular clear soda-lime glass (E1-E4, C1-C10) and alumino-silicate glass substrates (E5-E11, C11-C12). Alumino-silicate glass substrates E9 to E12 and C12 were chemically tempered before ion implantation. The key implantation parameters, reflectance and scratch resistance measurements can be found in the tables below.

TABLE 4

| | | acceleration | | light | critical load | critical |
|---|---|---|---|---|---|---|
| | glass | voltage | ion dosage | reflectance | with 100 μm tip | load |
| reference | substrate | [kV] | [ions/cm²] | [%, D65, 2°] | [N] | increase |
| E1 | Sodalime | 20 | 6 × 10¹⁶ | 6.14 | 6.7 | 7% |
| E2 | Sodalime | 20 | 7 × 10¹⁶ | 5.47 | 6.5 | 3% |
| E3 | Sodalime | 20 | 8 × 10¹⁶ | 5.67 | 6.3 | 0% |
| E4 | Sodalime | 20 | 9 × 10¹⁶ | 4.99 | 6.2 | 0% |
| C1 | Sodalime | 0 | 0 | 7.9 | 6.3 | |
| C2 | Sodalime | 35 | 1 × 10¹⁷ | 6.37 | 5.0 | |
| C3 | Sodalime | 25 | 1 × 10¹⁷ | 5.5 | 4.4 | |
| C4 | Sodalime | 15 | 1 × 10¹⁷ | 5.5 | 4.8 | |
| C5 | Sodalime | 35 | 7.5 × 10¹⁵ | 7.9 | 7.3 | |
| C6 | Sodalime | 25 | 7.5 × 10¹⁵ | 7.9 | 7.5 | |
| C7 | Sodalime | 15 | 7.5 × 10¹⁵ | 7.9 | 7.6 | |
| C8 | Sodalime | 35 | 5 × 10¹⁶ | 7.4 | 8.0 | |
| C9 | Sodalime | 25 | 5 × 10¹⁶ | 7.9 | 7.7 | |
| C10 | Sodalime | 15 | 5 × 10¹⁶ | 7.8 | 7.6 | |

As can be seen from table 4, examples E1 to E4 according to the present invention, treatment of the sodalime glass samples with an ion beam comprising a mixture of single charge and multicharge ions of N, accelerated with the same specific acceleration voltage and at such specific dosage, applied to a glass substrate, leads to a reduced reflectance and at the same time to an unmodified or even increased scratch resistance, when compared to the untreated sodalime glass sample C1. Comparative sodalime examples C2 to C4 lead to reduced reflectance but also to reduced scratch resistance. Comparative sodalime examples C5 to C10 lead to increased scratch resistance but not to any significant reduction of reflectance.

TABLE 5

| | | acceleration | | light | critical | Critical |
|---|---|---|---|---|---|---|
| | | voltage | ion dosage | reflectance | load | load |
| reference | glass substrate | [kV] | [ions/cm²] | [%, D65, 2°] | [N] | increase |
| E5 | Aluminosilicate | 20 | 6 × 10¹⁶ | 5.85 | 10.2 | 24% |
| E6 | Aluminosilicate | 20 | 7 × 10¹⁶ | 5.35 | 10.0 | 22% |
| E7 | Aluminosilicate | 20 | 8 × 10¹⁶ | 5.13 | 9.9 | 21% |
| E8 | Aluminosilicate | 20 | 9 × 10¹⁶ | 4.66 | 8.9 | 9% |
| C11 | Aluminosilicate | | | 7.93 | 8.2 | |

As can be seen from table 5, examples E5 to E8 according to the present invention, treatment of the aluminosilicate glass samples with an ion beam comprising a mixture of single charge and multicharge ions of N, accelerated with the same specific acceleration voltage and at such specific dosage, applied to a glass substrate, leads to a reduced reflectance and at the same time to an increased scratch resistance, when compared to the untreated aluminosilicate glass sample C11.

TABLE 6

| | | acceleration | | light | critical | Critical |
|---|---|---|---|---|---|---|
| | | voltage | ion dosage | reflectance | load | load |
| reference | glass substrate | [kV] | [ions/cm²] | [%, D65, 2°] | [N] | increase |
| E9 | Aluminosilicate | 20 | 6 × 10¹⁶ | 6.15 | 9.7 | 18% |
| E10 | Aluminosilicate | 20 | 7 × 10¹⁶ | 5.56 | 10.1 | 23% |
| E11 | Aluminosilicate | 20 | 8 × 10¹⁶ | 5.48 | 10.6 | 29% |
| E12 | Aluminosilicate | 20 | 9 × 10¹⁶ | 5.06 | 8.2 | 0% |
| C12 | Aluminosilicate | | | 7.82 | 8.0 | |

As can be seen from table 6, examples E9 to E12 according to the present invention, treatment of the chemically strengthened aluminosilicate glass samples with an ion beam comprising a mixture of single charge and multicharge ions of N, accelerated with the same specific acceleration voltage and at such specific dosage, applied to a glass substrate, leads to a reduced reflectance and at the same time to an unmodified or even increased scratch resistance, when compared to the untreated, chemically strengthened aluminosilicate glass sample C12. In the scratch resistance test, examples E9, E10, and E11 thus present a critical load increase of 18%, 23%, and 29% respectively, compared to the untreated glass substrate. On examples E9, E10, and E11 a scratch resistance in terms of critical load of 118%, 123%, and 129% respectively of the scratch resistance in terms of critical load of the untreated glass substrate was thus obtained.

Furthermore XPS measurements were made on the examples E1 to E12 of the present invention and it was found that the atomic concentration of implanted ions of N is below 8 atomic % throughout the implantation depth.

1. A method for producing an antireflective, scratch-resistant glass substrate, the method comprising:
a) providing a N₂ source gas,
b) ionizing the source gas so as to form a mixture of single charge ions and multicharge ions of N,
c) accelerating the mixture of single charge ions and multicharge ions of N with an acceleration voltage so as to form a beam of single charge ions and multicharge ions, wherein the acceleration voltage is comprised between 20 kV and 30 kV and the ion dosage is comprised between 5×10¹⁶ ions/cm² and 10¹⁷ ions/cm²,
d) providing a glass substrate, and
e) positioning the glass substrate in the trajectory of the beam of single charge and multicharge ions.

2. The method for producing an antireflective, scratch-resistant glass substrate according to claim 1, wherein the acceleration voltage is comprised between 22 kV and 28 kV and the ion dosage is comprised between 6×10¹⁶ ions/cm² and 9×10¹⁶ ions/cm².

3. The method for producing an antireflective, scratch-resistant glass substrate according to claim 2, wherein the acceleration voltage is comprised between 22 kV and 26 kV and the ion dosage is comprised between 8×10¹⁶ ions/cm² and 9×10¹⁶ ions/cm².

4. The method for producing an antireflective, scratch-resistant glass substrate according to claim 1, wherein the glass substrate has the following composition ranges expressed as weight percentage of the total weight of the glass:

| | |
|---|---|
| SiO₂ | 35-85%, |
| Al₂O₃ | 0-30%, |
| P₂O₅ | 0-20%, |
| B₂O₃ | 0-20%, |
| Na₂O | 0-25%, |
| CaO | 0-20%, |
| MgO | 0-20%, |
| K₂O | 0-20%, and |
| BaO | 0-20%. |

5. The method for producing an antireflective, scratch-resistant glass substrate according to claim 4, wherein the glass substrate is selected from the group consisting of a soda-lime glass sheet, a borosilicate glass sheet, and an aluminosilicate glass sheet.

6. A method, comprising employing a mixture of single charge and multicharge ions of N to decrease the reflectance of a glass substrate and at the same time to maintain or increase the scratch resistance of the glass substrate, the mixture of single charge and multicharge ions of N being implanted in the glass substrate with a dosage and an acceleration voltage effective to decrease the reflectance of the glass substrate and at the same time to obtain a scratch resistance in terms of critical load comprised between 100% and 135% of the scratch resistance in terms of critical load of the untreated glass substrate.

7. The method according to claim 6, wherein the mixture of single charge and multicharge ions is being implanted in the glass substrate with a dosage and acceleration voltage effective to reduce the reflectance of the glass substrate to at most 6.5%.

8. The method according to claim 7, wherein the mixture of single charge and multicharge ions is being implanted in the glass substrate with a dosage and acceleration voltage effective to reduce the reflectance of the glass substrate to at most 6%.

9. The method according to claim 8, wherein the mixture of single charge and multicharge ions is being implanted in the glass substrate with a dosage and acceleration voltage effective to reduce the reflectance of the glass substrate to at most 5%.

10. The method according to claim 6, wherein the mixture of single charge and multicharge ions is being implanted in the glass substrate with a dosage and acceleration voltage effective to obtain a scratch resistance in terms of critical load comprised between 105% and 135% of the scratch resistance in terms of critical load of the untreated glass substrate.

11. The method according to claim 6, wherein the acceleration voltage is comprised between 20 kV and 30 kV and the ion dosage is comprised between 5×10¹⁶ ions/cm² and 10¹⁷ ions/cm².

12. An antireflective, scratch-resistant glass substrate produced by a method according to claim 1.

13. A monolithic glazing, laminated glazing or multiple glazing with interposed gas layer, comprising an antireflective, scratch-resistant glass substrate according to claim 12.

14. The glazing of claim 13, further comprising sun-shielding, heat-absorbing, anti-ultraviolet, antistatic, low-emissive, heating, anti-soiling, security, burglar proof, sound proofing, fire protection, anti-mist, water-repellant, anti-bacterial or mirror means.

15. The glazing of claim 13, wherein said antireflective, scratch-resistant glass substrate is frosted, printed or screen process printed.

16. The glazing of claim 13, wherein said substrate is tinted, tempered, reinforced, bent, folded or ultraviolet filtering.

17. The glazing of claim 13, comprising a laminated structure comprising a polymer type assembly sheet interposed between the antireflective, scratch-resistant glass substrate, with the ion implantation treated surface facing away from the polymer assembly sheet, and another glass substrate.

18. The glazing of claim 17, wherein said glazing is a car windshield.
